(19) United States
(12) Patent Application Publication
(10) Pub. No.: US 2015/0379629 A1
(43) Pub. Date: Dec. 31, 2015

(54) INTERACTIVE WEB-ENABLED COMPUTER APPLICATION AND METHOD FOR PROVIDING EDUCATIONAL INFORMATION TO AND VERIFYING INFORMATION FROM A LOAN APPLICANT

(71) Applicant: Carrington Technology Solutions, LLC, Aliso Viejo, CA (US)

(72) Inventors: Bruce M. Rose, Greenwich, CT (US); Darren A. Fulco, Newport Coast, CA (US); Brent K. Rasmussen, Laguna Niguel, CA (US)

(21) Appl. No.: 14/318,062

(22) Filed: Jun. 27, 2014

(51) Int. Cl. G06Q 40/02; G09B 19/00; G09B 5/02; G09B 7/02

(52) U.S. Cl. CPC G06Q 40/02; G09B 5/02; G09B 7/02; G09B 19/00

(57) ABSTRACT

The present disclosure provides an interactive web-enabled computer application, and method of using the computer application, that (1) serves as a tool to educate loan applicants about relevant facts regarding their particular type of loan; (2) makes the applicants aware of their payment obligations and approximate residual income; (3) educates applicants about the consequences of missing payments; (4) requires the applicants to confirm personal information including, but not limited to, income and other debt obligations; and (5) documents that the applicants have been educated as described above, and that the applicants have verified their personal information.

### FIELD OF THE INVENTION

The present disclosure relates to an interactive web-enabled computer application, and method of using same, for educating loan applicants about the loan application process and terms of a loan, verifying loan applicant personal information, and documenting applicant education and verification.

### BACKGROUND OF THE INVENTION

Since the financial crisis of 2007-2008, there has been increased emphasis on ensuring that borrowers are able to repay their loans and are well-educated about the loan process and the terms of their loans. One of the contributing factors to the financial crisis was the increased granting of so-called subprime mortgages, including interest-only and other variable rate loans granted to individuals with relatively poor credit history.

In the wake of the crisis, lenders and investors are increasingly concerned about ensuring that their investments in mortgages are protected, so they have tightened credit standards, taken additional steps to vet borrowers, and employed additional borrower education programs in the lending process. Borrowers also want to ensure that they understand the terms of their loans so that they do not default in the future, risking the seizure of their property through foreclosure or other proceedings. Finally, regulators seek to protect borrowers, capital markets, and the economy from the negative effects of high default rates on loans.

Since the 2007-2008 crisis, lawmakers have passed several laws, including the 2010 Dodd-Frank Wall Street Reform and Consumer Protection Act, that impose new requirements on the lending industry. Likewise, regulators such as the Consumer Financial Protection Bureau (“CFPB”) have issued new rules and regulations under the Truth in Lending Act and the Dodd-Frank Act. These laws, rules, and regulations require, among other things, that lenders make a reasonable and good-faith determination that an application has a reasonable ability to repay the loan or meets the Qualified Mortgage rule standards. The rules outline several factors that lenders must consider before approving a loan, such as the applicant's income or assets, employment, and other ongoing debt obligations. Loan applicants also must supply personal financial information and lenders must verify it. The CFPB also issued new rules regarding borrower education under the Truth in Lending Act and the Real Estate Settlement Procedures Act.

In view of these and other recent laws, regulations, and rules, it is important for lenders to document that they have educated borrowers about the loan process and terms of the loan; verified the applicant's income, assets, and debt obligations; and made a determination whether the application has a reasonable ability to repay the loan.

What is needed is an interactive computer application platform that: (1) serves as a tool to educate loan applicants about relevant facts regarding their particular type of loan; (2) makes the applicant aware of their payment obligations and approximate residual income; (3) educates applicants about the consequences of missing payments; (4) requires the applicant to confirm personal information including, but not limited to, income and other debt obligations; and (5) provides a means for documenting that the applicants have been educated as described above, and that the applicants have verified their personal information.

### BRIEF SUMMARY OF THE INVENTION

Among the various aspects of the present disclosure is an interactive web-enabled application, and method of using same, for providing loan applicants with information regarding the loan market, the features of loans, and the specific terms of the loan for which they have applied. The present disclosure further describes means for verifying applicant personal information. Accordingly, the present disclosure addresses loan applicant education and serves as a verification tool for lenders. The method and systems described herein may be useful for a variety of loan types, including loans secured by property (e.g., mortgage loans).

At a particular milestone or milestones in the loan application process, it would be beneficial to present the applicant with information to educate the applicant about the loan application process, the terms of the loan, and the repayment of the loan. It would also be beneficial to provide an interactive web-enabled application through which loan applicants can verify their personal information including, but not limited to, the applicant's name, date of birth, contact information, social security number, loan amount, down payment, loan term, interest rate, income, assets, and/or other outstanding debt obligations.

The computer application described herein may be securely designed and provide the consumer with the ability to self-register. During the registration process, the applicant may be asked to provide certain information to verify the applicant's identity. Such information may then be cross-checked against data within the lender's loan origination system or other referential sources. The computer application may ask the applicant to create a user name for login purposes or, alternatively, a user name may be assigned to the applicant based on the applicant's name, loan application number, or other information. The computer application may further require the applicant to specify and confirm a password to be used when logging in, so as to authenticate the user. The computer application may require that the user authenticate him or herself, such as by prompting the user to enter a username and password, or by undertaking other steps to authenticate the user.

Either prior to or after the applicant is registered, the computer application may automatically check with the lender's loan origination system and/or other sources to ensure that the loan application has reached the proper milestone in the loan application process, that information about the loan application is available to the computer application, and that the information has passed auto-verification for accuracy. Based on the particular type and characteristics of the applicant's loan application, the computer application may determine which of a plurality of pre-programmed applicant education modules will be presented to the loan applicant.

In the event that an applicant registers for the computer application described herein before the milestone in the loan application process that triggers the applicant education and verification stage, the computer application may advise the applicant that no actions or information are required at that time. The computer application may subsequently send a message (e.g., via email or text message) to alert the applicant to log in to the computer application once the milestone is reached.

Once the appropriate milestone in the loan application is reached and the applicant logs in to the computer application, the applicant may be presented with a series of screens that contain information about the mortgage market and the parties they will encounter in seeking a loan, personal information that was provided as part of their loan application, details regarding the property that is securing the loan, and specific terms and details of their loan. The applicant education modules may include, but are not limited to, the following topics: operation, functionality, and purpose of the computer application; definition of the relevant loan type; definition and description of a mortgage loan; identification and description of the key parties in the loan process including, without limitation, the loan officer, appraiser, underwriter, loan processor, and closing agent; explanation of the loan underwriting and approval process; description of the roles of investors that buy and sell loans after they are originated; mortgage insurance; explanation of relevant requirements and standards governing information required for a loan application; consequences of missed or late loan payments; home value and appraisals; loan amortization relevant to the applicant's loan application; escrow accounts; budgeting and residual income; the closing process; closing expenses; the role of a loan servicer; and loan payment options. The computer application may log the applicant education modules that are presented to and reviewed by the applicant.

After presenting the relevant applicant education modules, the computer application may request that the applicant verify understanding of the topics presented by answering one or more questions. The questions may be in various formats, including “yes/no” questions asking whether the applicant understands the information presented. Optionally, if the applicant answers “no” or otherwise responds to a question by indicating the applicant does not understand, the computer application may provide a means for the applicant to submit questions or explain what information is not understood. The computer application may log the applicant's responses to the education verification questions and report to the lender if there are any topics not understood.

The computer application may also present the applicant with applicant personal information that was provided or determined as part of the loan application. The applicant personal information may include, but is not limited to, applicant name, date of birth, phone number, email address, mailing address, and social security number; address of the property being purchased; amount of loan; type of loan; down payment; term of loan; interest rate; annual or monthly income; other monthly debt payments not directly associated with the loan; and applicant assets. The applicant may be asked by the computer application to confirm that the applicant personal information is correct. In the event that any such information is incorrect, the computer application may allow the applicant to make or request corrections to the information, and the computer application may transmit such corrections or requests to the lender and the lender's loan application system to update all records. For some information, such as changes to the applicant's income, the applicant may not be permitted to change the information directly. Instead, the computer application may receive the applicant's response indicating the information is incorrect and subsequently notify the lender that material changes to the loan application may be necessary.

The computer application may be integrated with a loan origination system, which allows for loan and applicant-specific information to populate the application. The computer application may dynamically present different materials depending on what type of loan the applicant is seeking For example, if the applicant has elected to apply for a loan that requires an escrow account, the application may dynamically present information that is specific to the use of escrow accounts. This dynamic content capability also includes, but is not limited to, specific loan types, other variable characteristics of the loan, amortization schedules, detailed documentation, and alternate information and call to action based on applicant response.

The computer application may also utilize information from the applicant's underwriting file and other elements via integration with systems and data to present information pertaining to the applicant's ability to repay the loan.

The computer application may also provide an interface for loan officers and/or other roles within the loan process. This enables additional information to be uploaded, the status of applicant's actions to be reviewed, and each applicant response to questions to be viewed. This feature aids in remote support for the consumer. In addition, the application may alert the proper personnel at the lender to various status changes in the process (such as the consumer requiring additional information, negative or incorrect responses or attestations).

The computer application is configurable and may be customized by the lending institution. These configurable attributes may include, but are not limited to, such things as adding new loan products, changing the characteristics of dynamic responses and presentation materials, adding or adjusting underlying calculations and algorithms, messaging with loan officers and other participants in the loan process, qualifications for consumer participation, and trigger points within the loan process. All consumer interactions with the application may be logged and retained in a database.

### BRIEF DESCRIPTION OF THE DRAWINGS

For purposes of understanding the disclosure and the embodiments described herein, two drawings are provided. It should be understood, however, that the present invention is not limited to the precise arrangements or instrumentalities shown.

FIG. 1 is a simplified block diagram of a system used for performing a method of educating loan applicants about various aspects of the loan process and verifying applicant personal information;

FIG. 2 is a simplified block diagram illustrating the steps involved in a method of educating loan applicants about various aspects of the loan process, verifying applicant personal information, and documenting such activities, all using a computer application.

### DETAILED DESCRIPTION

### 1. Definitions

“Applicant” refers to a person, group, or business entity applying for a loan.

“Applicant personal information” refers to information about the applicant and/or specific to the applicant's loan application. Such information includes, but is not limited to, applicant name, date of birth, phone number, email address, mailing address, and social security number; address of the property being purchased; amount of loan; type of loan; down payment; term of loan; interest rate; annual or monthly income; other monthly debt payments not directly associated with the loan; and applicant assets.

“Computer” refers to desktop personal computers, laptop computers, tablets, smart phones, or other such devices capable of running internet-based or downloadable software programs.

“Computer Application” refers to software that can be used on a computer.

“Loan origination system”—a computer application or software program used by lenders to manage and document aspects of the loan process including, but not limited to, sales and marketing, application processing, underwriting, closing and funding, and various post-closing activities. Examples of loan origination systems include, without limitation, Ellie Mae Encompass.

“Milestone” refers to a point in the loan application process at which time it is appropriate or necessary for the applicant to confirm understanding of various loan-related topics and/or to verify applicant personal information.

“Mortgage Loan” refers to a loan secured by real estate.

### 2. Detailed Description

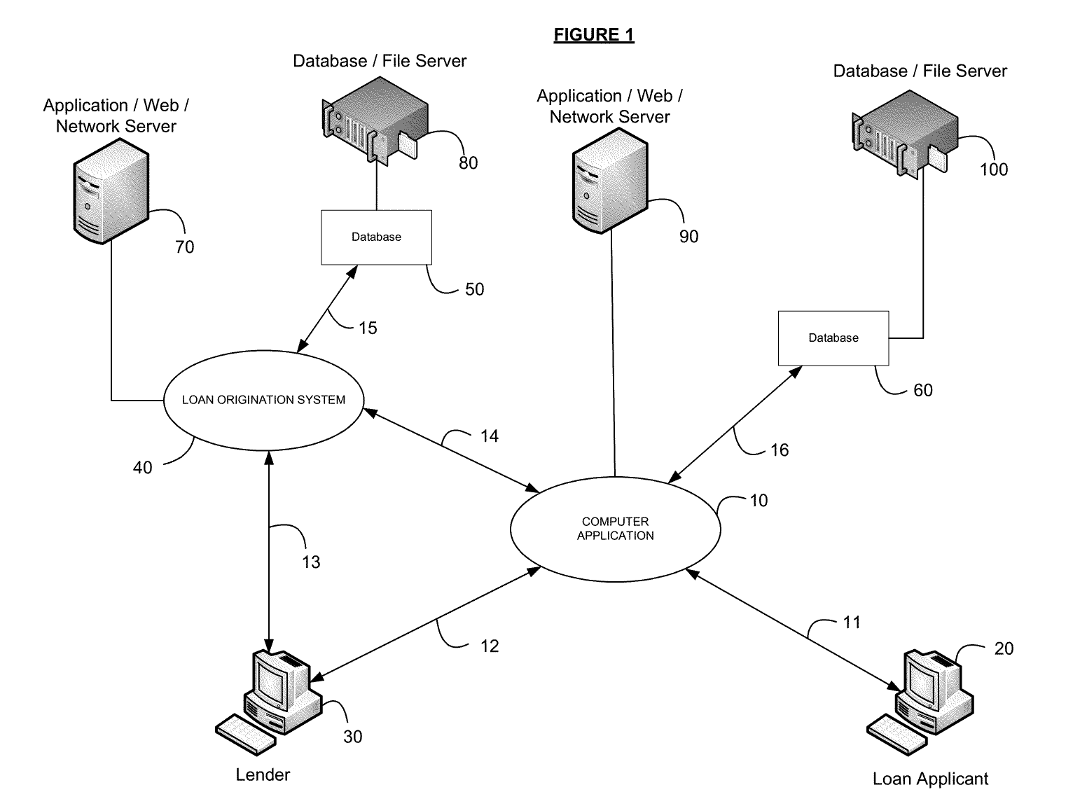

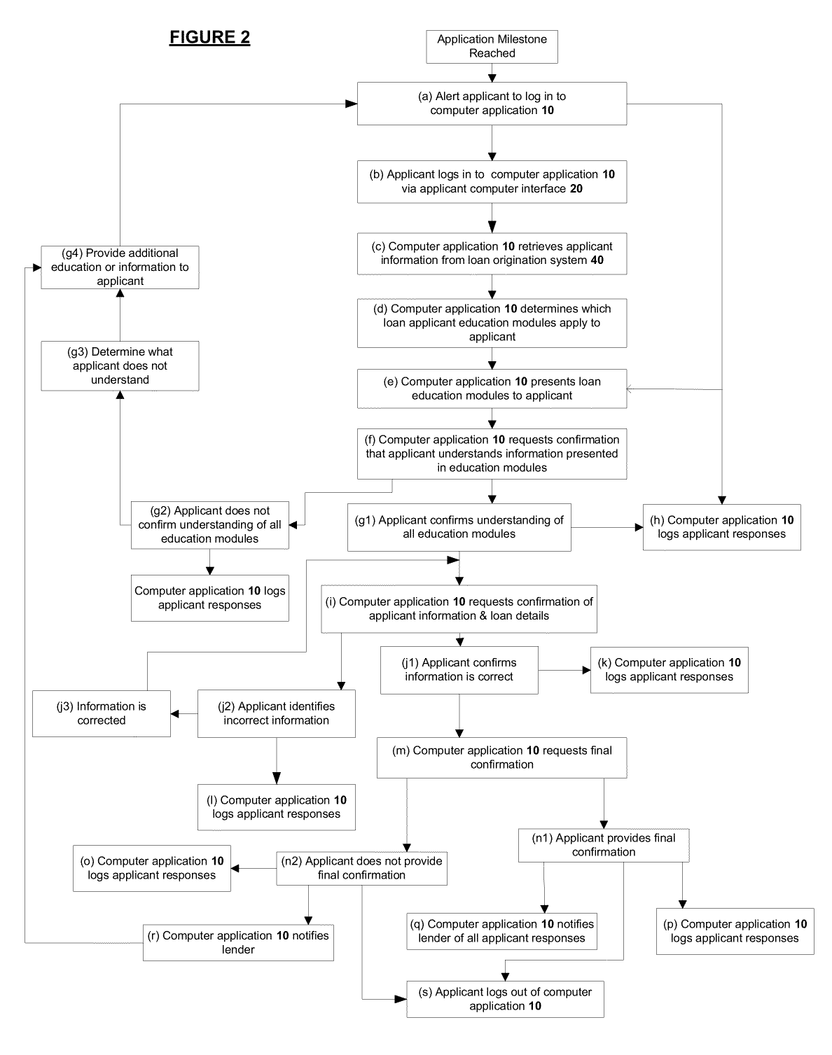

Embodiments of the present invention shall be described in detail with references to FIGS. 1-2. Although embodiments of the present invention will be described hereinafter, it shall be understood that the detailed discussion of such embodiments is not intended to limit the present invention to those particular embodiments.

An embodiment of the present invention is illustrated in FIG. 1. In accordance with the illustrated embodiment, a web-enabled computer application 10 may be located on an application/web/network server 90. Such servers include, but are not limited to, Windows Server, Windows Web Server, Windows Application Server, Windows Web Services API Server and Windows Internet Information Services. The computer application 10 may be an interactive program for displaying education modules for review by a loan applicant, for receiving confirmation that the loan applicant understands the information covered in the education modules, and/or for verifying loan applicant personal information. Additional details of the computer application 10 are described below.

In one embodiment, loan applicants may interface with computer application 10 using computer 20. Information may be transmitted between computer application 10 and computer 20 using internet/network connection 11. Computer 20 may comprise, without limitation, desktop personal computers, laptop computers, tablets, smart phones, or other such devices capable of running internet-based or downloadable software programs. In one embodiment, the loan applicant accesses and interfaces with computer application 10 using a web browser on computer 20. In alternative embodiments, computer 20 may be configured with a downloadable program or application that interfaces with computer application 10.

In one embodiment, computer application 10 receives information from and stores information in database 60, which may be located on server 100. Server 100 may be a database server and/or file server and may include, without limitation, MS SQL Servers and Windows Servers. Computer application 10 may transmit information to and from database 60 via network connection 16.

In accordance with the present disclosure, computer application 10 may be used in conjunction with any loan origination system 40. Loan origination system 40 may be located on application/web/network server 70. Alternatively, loan origination system 40 may be available via a Hosted ASP/SaaS solution. Loan origination system 40 may transmit information to and from database 50 via network connection 15. Lenders may access loan origination system 40 using lender computer 30. Information may be transmitted between loan origination system 40 and lender computer 30 using internet or network connection 13. Computer application 10 may transmit information to and receives information from loan origination system 40 via web services, internet, or network connection 14.

In alternative embodiments, two or more of computer application 10, database 60, loan origination system 40, and/or database 50 may be located on the same physical server (i.e., Virtual Servers). In another embodiment, database 50 and database 60 may be the same database or otherwise share information. In yet another embodiment, loan origination system 40 may be installed directly on lender computers 30 and may receive information from and store information in database 50.

FIG. 2 provides a flow diagram of an embodiment of the use of the computer application 10 to educate applicants about the loan process and to verify applicant personal information used in the loan process. As shown in FIG. 2, the use of computer application 10 may be triggered by reaching a particular milestone in the loan application. At that milestone, step (a) occurs with the loan applicant being alerted to log in to computer application 10. The alert to log in to computer application 10 may be provided via email, text message, or person-to-person communication, and may automatically occur once the loan origination system 40 and/or computer application 10 determine that the loan application milestone has been reached and the associated information passed automated quality checks. Once the milestone that triggers the use of computer application 10 is reached, computer application 10 may log all information associated with an applicant's use of the computer application, including, without limitation, all alerts to log in to the application, all successful or unsuccessful login attempts, tracking of all information reviewed by the applicant, all responses provided by the applicant, and date/time stamps for such information.

If the loan applicant has not previously logged in to computer application 10, the applicant may be asked to self-register. During the registration process, computer application 10 may require the applicant to provide certain information to verify the applicant's identity. Such information may be entered using applicant computer 20 and may then be cross-checked against data within the lender's loan origination system 40 or other referential sources. The computer application 10 may ask the applicant to create a user name for login purposes or, alternatively, a user name may be assigned to the applicant based on the applicant's name, loan application number, or other information. The computer application 10 may further require the applicant to specify and confirm a password to be used when logging in. The registration criteria may be customized to suit differing requirements, such as password complexity and authentication data elements.

At step (b), the applicant logs in to computer application 10 via applicant computer interface 20. Once the applicant logs in, computer application 10 may determine if the applicant is a returning applicant which may result in allowing the applicant to continue from a previously completed step, or computer application 10 may perform step (c) to retrieve applicant information from loan origination system 40, including details of the applicant's loan application and personal information. In alternative embodiments, the applicant information is retrieved by computer application 10 from database 60, from alternate databases where a subset of applicant data is stored, or from other lender databases where such information is stored.

At step (d), computer application 10 may determine which applicant pre-programmed education modules are relevant to the applicant's loan application. The applicant education modules may include, but are not limited to, the following topics: (1) operation, functionality, and purpose of the computer application 10; (2) definition of the relevant loan type; (3) definition and description of a mortgage loan; (4) identification and description of the key parties in the loan process including, without limitation, the loan officer, appraiser, underwriter, loan processor, and closing agent; (5) explanation of the loan underwriting and approval process; (6) description of the roles of investors that buy and sell loans after they are originated; mortgage insurance; (7) explanation of relevant requirements and standards governing information required for a loan application; (8) consequences of missed or late loan payments; (9) home value and appraisals; (10) loan amortization relevant to the applicant's loan application; (11) escrow accounts; (12) budgeting and residual income; (13) the closing process; (14) closing expenses; (15) the role of a loan servicer; and (16) loan payment options.

During step (d), computer application 10 may determine which applicant education modules are needed depending on what type of loan the applicant is seeking. For example, if the applicant has elected to apply for a loan that requires an escrow account, computer application 10 will dynamically present information that is specific to the use of escrow accounts. This dynamic content capability also includes, but is not limited to, specific loan types, other variable characteristics of the loan, and alternate information and call to action based on applicant response.

At step (e), computer application 10 may present the information contained in the applicant education modules. Such information for each applicant education module may be displayed on a series of screens on applicant computer 20. Alternatively, all applicant education modules may be grouped together into one or more groups of information to be displayed on one or more screens on applicant computer 20.

At step (f), computer application 10 may request confirmation that the applicant understands the information presented in the applicant education modules. In one embodiment, such confirmation is requested after each individual education module is presented. The requests may be in the form of “yes/no” questions or other forms. For each education module, there may be more than one confirmation request related to different aspects of that education module. In alternate embodiments, the confirmation request(s) may be performed after multiple or all of the education modules have been reviewed. The applicant response may be logged in database 60 thoroughout the process and may include the applicant user id, time, date, and responses to questions.

If computer application 10 receives from the applicant responses indicating that the applicant understands each of the education module topics (step (g1)), then computer application 10 may perform step (h) to log the applicant's responses. The responses may be logged in database 60 and/or sent to loan origination system 40.

If computer application 10 receives from the applicant any responses indicating that the applicant does not understand one or more of the education module topics (step (g2)), then step (g3) and step (g4) may be performed. In steps (g3) and (g4), the computer application 10 may alert the lender who may determine what information the applicant does not understand and provide further instruction or education on the topic. The applicant may then be instructed to complete some or all of the applicant education modules in computer application 10 and to confirm the applicant understands all topics (steps (a) through (g1)). In one embodiment, computer application 10 will only require the applicant to re-perform steps (a) through (g1) for the education modules for which the applicant provided responses indicating information was not understood.

In alternative embodiments, if an applicant does not understand the information presented in certain applicant education modules, the computer application 10 may provide means for submitting specific questions to the lender or otherwise indicating what information is not understood.

After review of the applicant education modules is complete, computer application 10 may perform step (i) and presents to the applicant certain applicant personal information to be verified. During this step, applicant personal information may be presented on one or more screens of applicant computer 20. The applicant personal information may comprise, without limitation, applicant name, date of birth, phone number, email address, mailing address, and social security number; address of the property being purchased; amount of loan; type of loan; down payment; term of loan; interest rate; annual or monthly income; other monthly debt payments not directly associated with the loan; and applicant assets. As with other actions performed by the applicant and/or responses provided by the applicant, computer application 10 may log the actions/responses throughout the process.

If the applicant identifies information and/or responses that are incorrect (step (j2)), then step (j3) may be performed to correct the information and/or responses. To complete this step, the applicant may submit an information correction request through applicant computer 20 and/or via communication with Lender. Alternatively, depending on the type of information that requires correction, the applicant may be allowed to enter the correct information through applicant computer 20. This may be permissible, for example, with basic information such as the applicant phone number. For other information, such as the applicant's income, step (j3) may require the lender to make the changes and, if necessary, to start the entire loan application over. In one embodiment, computer application 10 logs the applicant's responses in database 60 or elsewhere on the network accessible by the lender (see steps (k) and (l)).

At step (m), computer application 10 may request final confirmation that the applicant has understood the program, completed the questions on his/her own without coercion or coaching, and understands that the Lender may be contacted for any questions. If the applicant responds in the affirmative (step (n1)), then computer application 10 may perform step (p) to log the applicant's response and step (q) to notify the lender of the applicant's responses and update loan origination system 40 with milestone/step completion data and documentation. The computer application 10 may also provide the applicant with the ability to print a certificate of completion, print a copy of all responses, and/or to log out of the application (step (s)).

In the event that the applicant responds in the negative to the requests for final confirmation (step (n2)), then computer application 10 may perform step (o) to log the applicant's response and step (r) to notify the lender of the applicant's responses. The computer application 10 may also allow applicant to review the material and responses and/or contact the Lender for clarification, further information, or corrections. The applicant may elect to log out of the application (step (s)).

Although the embodiment disclosed in FIG. 2 provides for steps to be performed in the illustrated sequence, the steps of the present invention may be performed in a different order. For example, in one embodiment, the verification of applicant personal information may be performed before the applicant education steps. In another embodiment, certain applicant education modules may be completed, followed by certain personal information verification steps, followed by additional education modules. In all cases, some or all of the applicant's responses to the education module and personal information verification steps are logged by the computer application.

Another aspect disclosed herein is that the lender may access the computer application 10 via lender computer 30. The lender interface to computer application 10 may provide the lender with the ability to determine the status of multiple applications including, but not limited to: (1) whether applicants have reviewed applicant education modules; (2) which application education modules the applicant reviewed; (3) whether the applicant responded in the affirmative to the request to confirm understanding of the educational module information; (4) whether the applicant requires further education on certain topics related to the loan process; (5) whether the applicant confirmed that the applicant personal information is correct; (6) whether the applicant changed any applicant personal information; (6) whether the applicant confirmed he/she has the ability to repay the loan; and (7) the date(s) and time(s) that the applicant accessed the computer application.

In another embodiment, the computer application 10 is integral with and part of the loan origination system 40.

The computer application and related components can be implemented in digital electronic circuitry, or in computer hardware, firmware, software, or in combinations of them. The computer application and related components can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps described herein can be performed by one or more programmable processors executing a computer program to perform the stated functions by operating on input data and generating output. Method steps can also be performed by, and the computer application and related components can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

While the above description contains many specific details, these should not be construed as limitations on the scope of the invention, but rather as exemplifications of one or more embodiments thereof. Other variations are possible. Accordingly, the scope of the invention should be determined not by the embodiments illustrated or described, but by the appended claims and their legal equivalents, as set forth hereinafter.

What is claimed is:

1. A method of educating a loan applicant and verifying loan applicant personal information, said method comprising the steps of:
(a) Providing a computer application located on a network server, said computer application being capable of receiving information from and transmitting information to a lender and a loan applicant, said computer application comprising a plurality of education modules;
(b) Transmitting information associated with a loan application of said loan applicant to said computer application;
(c) Determining which of the said plurality of education modules are relevant to said loan applicant's loan application;
(d) Providing, using said computer application, the relevant education modules to said loan applicant;
(e) Sending, using said computer application, at least one request for confirmation that said loan applicant reviewed and understood the information set forth in said education modules;
(f) Receiving, by said computer application, applicant's responses to said at least one request for confirmation that said loan applicant reviewed and understood the information set forth in said education modules;
(g) Providing, via said computer application, loan applicant personal information for review by said loan applicant;
(h) Sending, using said computer application, at least one request for confirmation that said loan applicant personal information is correct;
(i) Receiving, by said computer application, loan applicant's response to said at least one request for confirmation that said loan applicant personal information is correct;
(j) Logging, at one or more databases in communication with said computer application, said loan applicant's responses to all requests for confirmation.

2. The method of claim 1, wherein the information transmitted in step (b) is transmitted from a loan origination system.

3. The method of claim 2, wherein step (c) is performed automatically by said computer application after receiving said information associated with said loan applicant's loan information.

4. The method of claim 1, wherein the loan application is a mortgage loan application.

5. The method of claim 1, further comprising the step of authenticating the loan applicant.

6. The method of claim 1, wherein said computer application is integral with a loan origination system.

7. The method of claim 1, wherein the loan applicant personal information comprises applicant name, applicant date of birth, applicant phone number, applicant email address, applicant mailing address, applicant social security number, address of the property being purchased, loan amount applied for; type of loan applied for; down payment; term of loan; interest rate; applicant annual or monthly income, other applicant monthly debt payments not directly associated with the loan, and/or applicant assets.

8. The method of claim 1, wherein said plurality of education modules comprise the topics of defining the applicant's loan type, defining and describing a mortgage loan, identifying and describing the parties involved in the loan process including, explaining the loan underwriting and approval process, describing the roles of investors that buy and sell loans after they are originated, defining and describing mortgage insurance, explaining the requirements and standards governing information required for a loan application, explaining the consequences of missed or late loan payments, home value and appraisals, loan amortization, escrow accounts, budgeting and residual income, the closing process, closing expenses, the role of a loan servicer, and/or loan payment options.

9. The method of claim 1, further comprising the step of providing a lender interface to said computer application, wherein said lender interface displays the status of said loan applicant's responses to all said requests for confirmation.

10. A system for educating a loan applicant and verifying loan applicant personal information, said system comprising:
a server;
a database;
a computer application located on said server, said computer application configured to:
(a) receive information from and transmit information to a lender and a loan applicant;
(b) comprise a plurality of education modules;
(c) receive information associated with a loan application of said loan applicant;
(d) determine which of the said plurality of education modules are relevant to said loan applicant's loan application;
(e) display the relevant education modules for review by said loan applicant;
(f) send at least one request for confirmation that said loan applicant reviewed the information set forth in said education modules and understood the information set forth in said education modules;
(g) receive said loan applicant's responses to said at least one request for confirmation that said loan applicant reviewed and understood the information set forth in said education modules;
(h) display loan applicant personal information for review by said loan applicant;
(i) send at least one request for confirmation that said loan applicant personal information is correct;
(j) receive said loan applicant's response to said at least one request for confirmation that said loan applicant personal information is correct;
(k) log, at one or more databases in communication with said computer application, said loan applicant's responses to all requests for confirmation;
a lender computer, said lender computer configured to transmit information to and receive information from said computer application.

11. The system of claim 10, wherein the computer application is further configured to receive said information associated with said loan applicant's loan application from a loan origination system.

12. The system of claim 11, wherein the computer application is further configured to automatically determine which of the said plurality of education modules are relevant to said loan applicant's loan application after receiving said information associated with said loan applicant's loan information.

13. The system of claim 10, wherein the loan application is a mortgage loan application.

14. The system of claim 10, wherein the computer application is further configured to authenticate the loan applicant.

15. The system of claim 10, wherein said computer application is integral with a loan origination system.

16. The system of claim 10, wherein the loan applicant personal information comprises applicant name, applicant date of birth, applicant phone number, applicant email address, applicant mailing address, applicant social security number, address of the property being purchased, loan amount applied for; type of loan applied for; down payment; term of loan; interest rate; applicant annual or monthly income, other applicant monthly debt payments not directly associated with the loan, and/or applicant assets.

17. The system of claim 10, wherein said plurality of education modules comprise the topics of defining the applicant's loan type, defining and describing a mortgage loan, identifying and describing the parties involved in the loan process including, explaining the loan underwriting and approval process, describing the roles of investors that buy and sell loans after they are originated, defining and describing mortgage insurance, explaining the requirements and standards governing information required for a loan application, explaining the consequences of missed or late loan payments, home value and appraisals, loan amortization, escrow accounts, budgeting and residual income, the closing process, closing expenses, the role of a loan servicer, and/or loan payment options.

18. The system of claim 10, wherein said lender computer displays the status of said loan applicant's responses to all said requests for confirmation by the computer application.
